(19) United States
(12) Patent Application Publication
(10) Pub. No.: US 2015/0170801 A1
(43) Pub. Date: Jun. 18, 2015

(54) SYSTEM FOR MANUFACTURING A COIL TUBING WITH THE TUBING ENCAPSULATED CABLE INCORPORATED INTO THE COIL TUBING

(71) Applicant: Trican Well Service, Ltd., Calgary (CA)

(72) Inventors: Craig Talbot, Calgary (CA); Scott Sherman, Blackie (CA)

(73) Assignee: Trican Well Service, Ltd., Calgary (CA)

(21) Appl. No.: 14/564,855

(22) Filed: Dec. 9, 2014

Related U.S. Application Data
(60) Provisional application No. 61/915,903, filed on Dec. 13, 2013.

(51) Int. Cl. H01B 13/22; B23K 31/02; H02G 1/00

(52) U.S. Cl. CPC H01B 13/22; H02G 1/00; B23K 31/027

(57) ABSTRACT

Tubing encapsulated cable is generally difficult to place in the interior of the coil tubing. It has been found that in certain circumstances the process of placing the tubing encapsulated cable in the interior coil tubing is simplified by manufacturing the coil tubing with the tubing encapsulated cable already in place in the interior of the coil tubing. In the instance when a tubular is formed by curving the edges of the a flat plate into the tubular shape, along the flat plate's long axis, the tubing encapsulated cable is unspooled to the interior of the coil tubing prior to the edges of the flat plate being welded together to form the coil tubing. Or when the coil tubing is formed by spiral wrapping the flat plate, at an angle to the flat plate's long axis, into a tubular shape, again the tubing encapsulated cable is unspooled to the interior of the tubular shape prior to the edges of the flat plate being welded together to form the coil tubing.

### CROSS-REFERENCE TO RELATED APPLICATIONS

This application claims priority to U.S. Provisional Patent Application No. 61/915,903 that was filed on Dec. 13, 2013.

### BACKGROUND

Tubing encapsulated cable can be difficult to insert into coil tubing. Tubing encapsulated cable typically consists of one or more electrical conductors, a fiber optic cable, and possibly other cables or lines sheathed in a corrosion resistant alloy such as 316 stainless steel or a fiber reinforced composite sheath. The smooth outside surface and relatively small diameter of tubing encapsulated cable are desirable attributes for well intervention work because the relatively smooth surface may be more resistant to chemical attack than braided wire. Additionally, the relatively smooth surface and small diameter (0.125″-0.250″) minimizes viscous drag exerted upon the cable as fluids pumped through the coil tubing in the course of intervention operations pass by the cable. Because there is little drag on the tube wire, conventional pumping operations used to install braided wireline into coil tubing are not sufficient to install tubing encapsulated cable. Pumping fluid through the coil tubing during the installation of tubing encapsulated cable is required to assist in overcoming the capstan effect, caused by the friction between the coil tubing and the tubing encapsulated cable as the tubing encapsulated cable travels through the wound coil tubing.

There are numerous techniques that may be utilized to install tubing encapsulated cable into a long tubular member such as coil tubing. Such as hanging the coil into the well in order to allow the somewhat reliable force of gravity to pull the tubing encapsulated cable downward into the interior of the coil tubing. Another commonly known technique involves spooling out the coil tubing along a roadway, installing a rope, cable, or equivalent and using the rope or cable in a manner similar to that of an electrician's fish tape to pull the tubing encapsulated cable into the coil tubing. In these instances fluid may or may not be pumped into the coil tubing while inserting the tubing encapsulated cable. Inserting the tubing encapsulated cable into coil tubing as described above can be an expensive operation. Wire and cable have been used with a tubular conduit since the late 1800s, conduit, like coil tubing, is a long tubular member that normally has wires and cables with a wide variety of outer armors run through it.

Another currently utilized method of installing tubing encapsulated cable into coil tubing is while pumping fluid through the coil tubing to attach a plug to the end of the tubing encapsulated cable. The plug will then pull the tubing encapsulated cable through the coil tubing as the plug is pumped through the coil tubing.

### SUMMARY

One solution to the problem of running a long tubing encapsulated cable into coil tubing is to add the tubing encapsulated cable to the coil tubing as the coil tubing is manufactured.

Coiled tubing is typically manufactured from flat strip metal stock, such as steel, that is rolled into a tube shape and then seam welded at the joint along the length to make a continuous piece of tubing. A tubing encapsulated cable, which can be a communication line, a power line, or both, is typically a small diameter tube, usually about ⅛″ to ¼″ diameter. Usually a communications line is placed in the tubing encapsulated cable. The communications line or lines may be copper wires, aluminum wires, fiber optic cable, or any other communications cable or line. The tubing encapsulated cable is laid over the top of the flat steel strip, and the flat steel strip is then rolled to a tubular shape around the tubing encapsulated cable and seam welded at the joint to form the coiled tubing. The tubing encapsulated cable outer sheath is typically stainless steel but may be any appropriate material. In certain embodiments the communications line may be a coated line, such as insulated metal or a fiber optic core with a carbon fiber or other coating.

### BRIEF DESCRIPTION OF THE DRAWINGS

FIG. 1 depicts an embodiment of a length of flat stock as it is rolled about its long axis into a tubular with tubing encapsulated cable in the interior of the tubular.

FIG. 2 depicts a detailed view of an embodiment of a length of flat stock as it is rolled about its long axis into a tubular with tubing encapsulated cable attached to the inner wall of the tubular.

FIG. 3 depicts a detailed view of an embodiment of a length of flat stock as it is rolled, at an angle to its long axis, into a tubular with tubing encapsulated cable in the interior of the tubular.

### DETAILED DESCRIPTION

The description that follows includes exemplary apparatus, methods, techniques, or instruction sequences that embody techniques of the inventive subject matter. However, it is understood that the described embodiments may be practiced without these specific details.

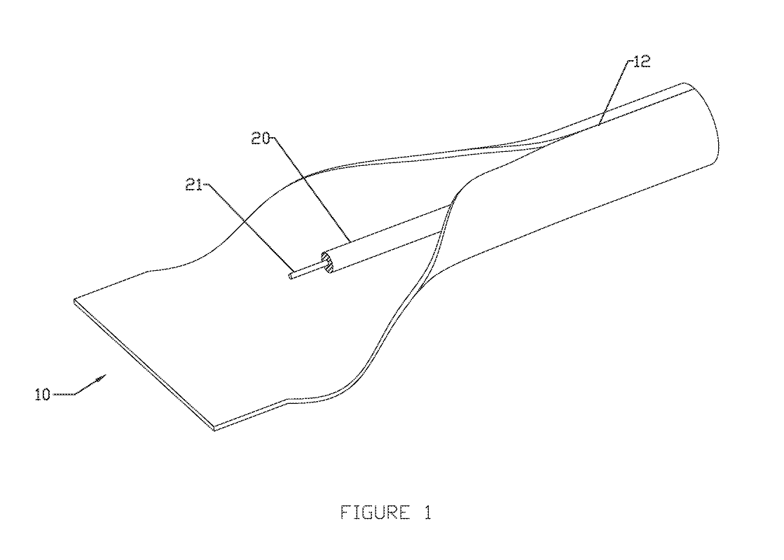

As described in FIG. 1 coiled tubing is typically manufactured from flat strip metal stock 10, such as steel, that is rolled into a tube shape and then seam welded at the joint 12 along the length to make a continuous piece of tubing. A tubing encapsulated cable 20, which can be a communication line, a power line, or both, is typically a small diameter tube, usually about ⅛″ to ¼″ diameter. When a communications line 21 is placed in the tubing encapsulated cable 20 the communications lines 21 may be copper wires, aluminum wires, fiber optic cable, or any other communications cable or line. The tubing encapsulated cable 20 is laid over the top of the flat steel strip 10, and the flat steel strip 10 is then rolled to a tubular shape around the tubing encapsulated cable 20 and seam welded at the joint 12 to form the coiled tubing. The tubing encapsulated cable 20 outer sheath is typically stainless steel but may be any appropriate material. In certain embodiments the communications line may be a coated line, such as insulated metal or a fiber optic core with a carbon fiber or other coating.

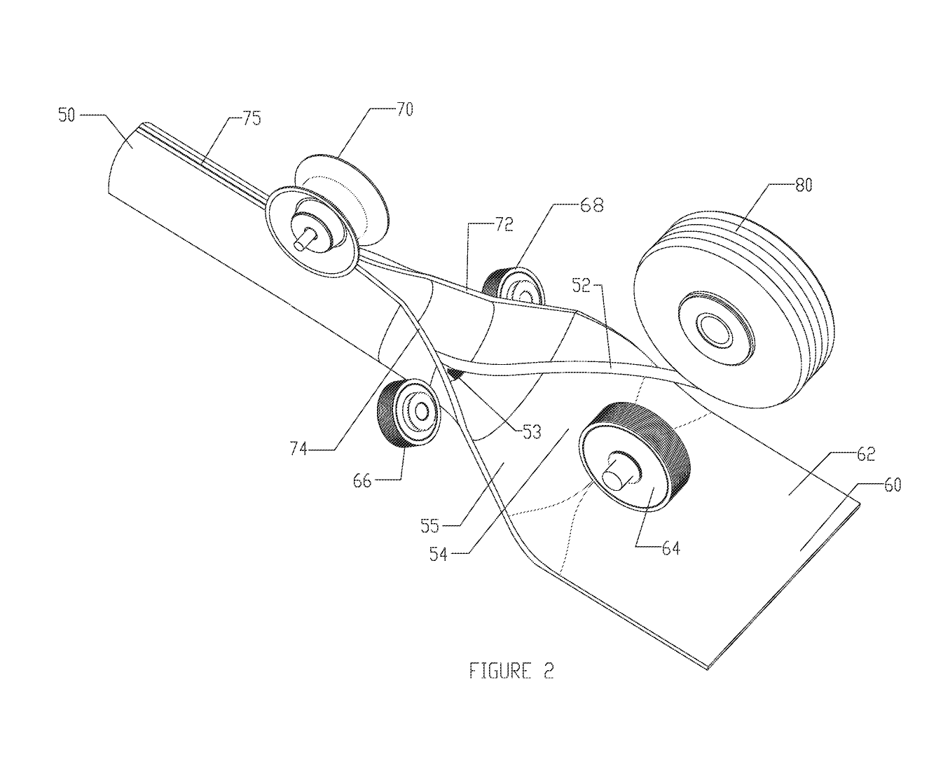

FIG. 2 depicts a more detailed view of the coil tubing 50 as tubing encapsulated cable 52 is placed in the interior 54 of the bent flat pate 62 that becomes the coil tubing 50. On the lower end 60 of the coil tubing 50 the coil tubing 50 begins as a relatively flat plate 62. As the flat plate 62 moves from the right to the left the flat plate 62 engages a series of rollers that form the flat plate 62 into a tubular. The flat plate 62 first engages roller 64. The flat plate 62 next engages roller 66 and roller 68. Roller 64 tends to apply downward pressure to the center of the flat plate 62 while rollers 66 and 68 apply upward pressure to either side of the center of flat plate 62. The counteracting pressure of roller 64 with respect to rollers 66 and 68 tends to bend the flat plate 62 to begin the formation of the tubular. Once the flat plate 62 is substantially bent into a tubular another roll forming wheel such as roller 70 may complete the process of forming the tubular by bending the first edge of the flat plate 72 so that it meets the opposing edge of the flat plate 74. Once the two edges 72 and 74 are substantially in contact with one another the two edges 72 and 74 may be welded along seam 75 to form coil tubing 50. While rollers have been discussed as being used to form the flat plate 62 into coil tubing 50 any known means of forming the coil tubing may be used. For instance dies, lubricated or not, that the metal is bent around and through, could be used to form the coil tubing 50 while inserting the tubing encapsulated cable either through or between the dies. In some cases it is advantageous to use a combination of rollers and dies, for instance rollers may be used and then a die may be used to correct eccentricities in the tubular.

At some point, typically after the flat plate 62 is initially bent by rollers 64, 66, and 68 but prior to the two edges 72 and 74 being brought together a tubing encapsulated cable 52 is unrolled from spool 80 so that the tubing encapsulated cable 52 will be in the interior of the coil tubing 50 after the two edges 72 and 74 are welded together. While typically the tubing encapsulated cable 52 is free floating in the interior 54 of the bent flat plate 62 the tubing encapsulated cable 52 may be attached to the inner surface 55 of the bent flat pate 62. The tubing encapsulated cable 52 may be attached to the inner surface 55 by an adhesive, by welding, by tabs that are in turn attached to the inner surface 55, or by any other means known in the industry.

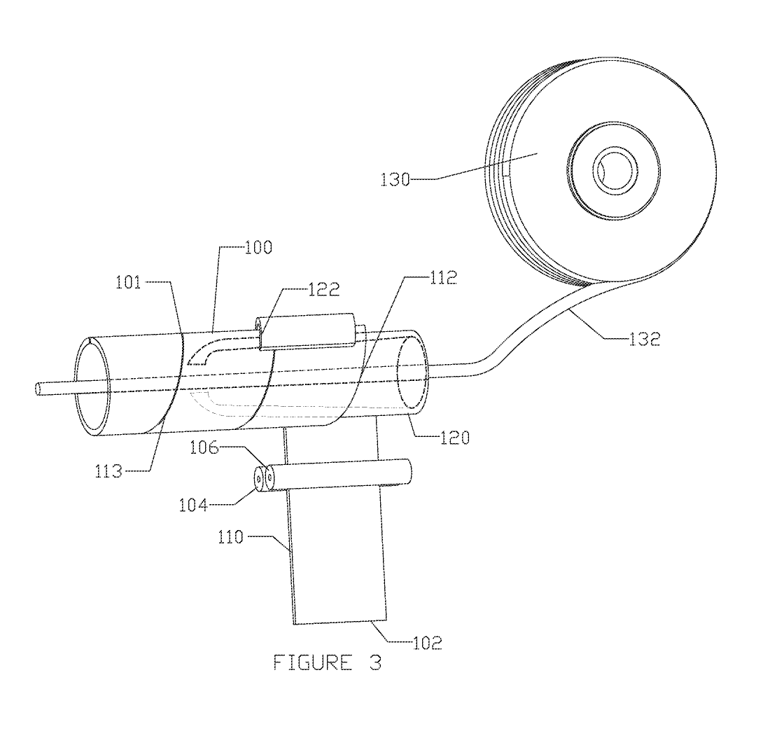

FIG. 3 depicts coil tubing 100 as it is being spiral wound. A flat plate 102 is fed at an angle into a first roller 104 and a second roller 106. The rollers 104 and 106 force the flat plate 102 into a die that bends the flat plate into a tubular where the flat plate first edge 110 contacts the flat plate second edge 112. The die has an inner mandrel 120 that the flat plate 102 bends around so as to assume the shape of a tubular. The die also has an outer sleeve 122 that fits around the mandrel 120. The sleeve 122 is spaced apart from the mandrel 120 in order to allow the flat plate 102 to move between the inner mandrel 120 and the outer sleeve 122 in turn forcing the flat plate 122 to assume the shape of the inner mandrel 120. Once the flat plate 102 has assumed the shape of the inner mandrel 120 and first edge 110 is in contact the flat plate second edge 112 the edges are welded along seam 113 to form the coil tubing 100. As the flat plate 102 is being formed into the coil tubing 100 tubing encapsulated cable 132 is being unwound from spool 130 where the tubing encapsulated cable 132 is fed through the interior of the inner mandrel 120 as the coil tubing 100 is being formed there by placing tubing encapsulated cable 132 in the interior of the coil tubing 100 for the length of the coil tubing 100 or the length of the tubing encapsulated cable 132. In certain instances rollers may be utilized in place of dies.

The methods and materials described as being used in a particular embodiment may be used in any other embodiment. While the embodiments are described with reference to various implementations and exploitations, it will be understood that these embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method of installing a tubing encapsulated cable in a coil tubing comprising,
bending the flat plate along the flat plate's longitudinal axis,
inserting a tubing encapsulated cable in the interior of the bent flat plate,
associating a first edge of the flat plate with a second edge of the flat plate, and
joining the first edge to the second edge.

2. The method of claim 1 wherein, the tubing encapsulated cable is attached to an interior of the coil tubing.

3. The method of claim 2 wherein, the tubing encapsulated cable is attached to the interior of the coil tubing by an adhesive.

4. The method of claim 2 wherein, the tubing encapsulated cable is attached to the interior of the coil tubing by a weld.

5. The method of claim 2 wherein, the tubing encapsulated cable is attached to the interior of the coil tubing by a tab.

6. The method of claim 1 wherein, the first edge is joined to the second edge by a weld.

7. The method of claim 1 wherein, the flat plate is bent by a roller.

8. The method of claim 1 wherein, the flat plate is bent by a die.

9. The method of claim 1 wherein, the flat plate is bent by a die and a roller.

10. A method of installing a tubing encapsulated cable in a coil tubing comprising,
engaging the flat plate with a set of rollers,
bending the flat plate at an angle to the flat plate's longitudinal axis,
inserting a tubing encapsulated cable in the interior of the bent flat plate,
associating a first edge of the flat plate with a second edge of the flat plate, and
joining the first edge to the second edge.

11. The method of claim 10 wherein, the tubing encapsulated cable is attached to an interior of the coil tubing.

12. The method of claim 11 wherein, the tubing encapsulated cable is attached to the interior of the coil tubing by an adhesive.

13. The method of claim 11 wherein, the tubing encapsulated cable is attached to the interior of the coil tubing by a weld.

14. The method of claim 11 wherein, the tubing encapsulated cable is attached to the interior of the coil tubing by a tab.

15. The method of claim 10 wherein, the first edge is joined to the second edge by a weld.

16. The method of claim 10 wherein, the flat plate is bent by a roller.

17. The method of claim 10 wherein, the flat plate is bent by a die.

18. The method of claim 10 wherein, the flat plate is bent by a die and a roller.
